(19) United States
(12) Patent Application Publication
(10) Pub. No.: US 2001/0001982 A1
(43) Pub. Date: May 31, 2001

(54) HEATING AND AIR CONDITIONING UNIT OF A MOTOR VEHICLE

(75) Inventors: NOUREDDINE KHELIFA, COBURG (DE); HORST RIEHL, RODACH (DE)

Correspondence Address: JOSEPH A CALVARUSO ESQ, MORGAN & FINNEGAN L L P, 345 PARK AVENUE, NEW YORK, NY, 101540053

(73) Assignee: DAVID M. BRUNO

(21) Appl. No.: 09/382,883

(22) Filed: Aug. 25, 1999

(30) Foreign Application Priority Data
Aug. 27, 1998 (DE) 198 39002.5

(51) Int. Cl. B60H 1/32; B60H 3/00; B61D 27/00; F25B 41/00; F25B 49/00; B60H 1/00; F25B 29/00

(52) U.S. Cl. 165/202; 165/42; 165/43; 165/140; 165/240; 62/196.4

(57) ABSTRACT

A heating and air conditioning unit of a motor vehicle has a heat exchanger that can be supplied with coolant of the engine and a compressor disposed in the refrigerant circuit of the air conditioning unit for the compression of a gaseous refrigerant. The heat exchanger 3, apart from the exchanger region 6 through which the coolant flows, has a separate exchanger region 7 for the heated refrigerant, which can be supplied with heated refrigerant via a bypass line 14 branching on the pressure side of the compressor 8 from the refrigerant circuit. The bypass line 14, after passing though the heat exchanger 3, discharges on the suction side of the compressor 8 again into the refrigerant circuit.

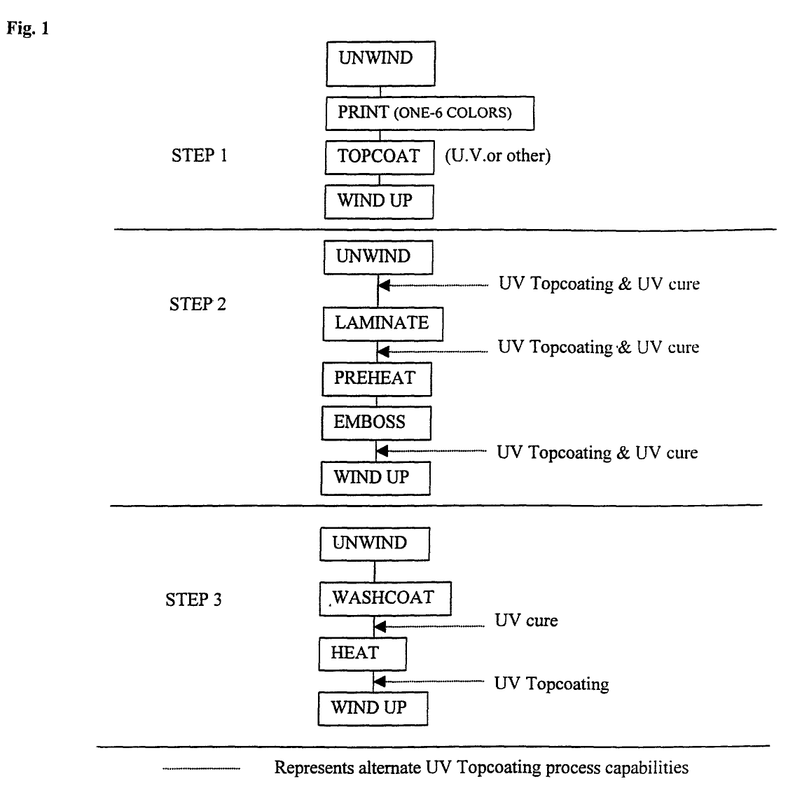

### FIELD OF THE INVENTION

The invention relates to a heating and air conditioning unit of a motor vehicle. More specifically the present invention related to a unit comprising a heat exchanger that can be supplied with coolant of the engine and further comprising a compressor disposed in the refrigerant circuit of the air conditioning unit for the compression of a gaseous refrigerant.

### BACKGROUND OF THE INVENTION

Modern internal combustion engines of motor vehicles which are designed for particularly good energy utilisation occasionally generate less waste heat than is required for comfort purposes, in particular for heating the interior space. In the case of such vehicles it is known to use supplementary heaters which meet the deficient heat requirement. Fuel heaters or electrically operated heaters are known as supplementary heaters. Moreover, it is known to use available air conditioning units for heating, in which case the hot refrigerant compressed by the compressor is branched from the refrigerant circuit via a bypass line and is conveyed through a heat exchanger. This heat exchanger is disposed in the stream of the air to be blown out, as is the heat exchanger through which the coolant flows, and warms said air if necessary.

A disadvantage of the known system is firstly the high installation and cost expenditure which accompanies the integration of two heat exchangers disposed one behind the other. Thus, said heat exchangers require a large installation area and present the through-flowing air with high resistance.

The increased resistance results in more power being required for the fan producing the air flow.

Therefore one aim of the invention is to design the heating and air conditioning unit of a motor vehicle so that, with a low constructional area, a supplementary heater is created with which the air stream conveyed into the interior of the vehicle can be effectively heated.

### SUMMARY OF THE INVENTION

This object may be achieved by a heating and air conditioning unit of a motor vehicle having a heat exchanger, a compressor and means for supply of engine coolant to the heat exchanger, the compressor being disposed in a refrigerant circuit of the air conditioning unit for the compression of a gaseous refrigerant, the unit further comprising a bypass line branching from the refrigerant circuit on the pressure side of the compressor for additional supply to the heat exchanger of heated refrigerant, whereby the bypass line, after passing through the heat exchanger discharges again into the refrigerant circuit on the suction side of the compressor

By the fact that the heat exchanger can be supplied with heated refrigerant not only by the coolant of the internal combustion engine but additionally also via a bypass line branching on pressure side of the compressor from the refrigerant circuit, the heating of the air stream can take place in a single heat exchanger. Through this heat exchanger can flow heated refrigerant in the starting phase of the engine, provided the cooling water is cold, and then can be switched over to normal coolant operation. The control of the flow of coolant and refrigerant occurs by controllable valves in the lines.

In a particularly advantageous embodiment, the heat exchanger has, apart from the line through which coolant flows, a separate line for the heated refrigerant. In this form the lines can be adapted to the particular needs of the liquid coolant and of the gaseous refrigerant and the exchange temperature of the heat exchanger can be adjusted via the separately adjustable flows in the coolant circuit and in the refrigerant circuit. Depending on the temperature of the coolant and refrigerant, the flows can be conveyed into the heat exchanger simultaneously or staggered in time.

An advantageous feature of the heating and air conditioning unit according to the invention is that the quantity of heat available in the motor vehicle can be optimally used to heat the air. At the same time, the system specified by the invention can be designed in a simple manner so that noises are minimised.

Overall, the system is distinguished by high reliability and by low provision costs on account of the reduction in necessary components. With good adaption of the geometry of the heat exchanger, a low air resistance can be achieved with effective heat transfer, so that the energy consumption necessary for the production of the air stream can be kept low. The fact that the system specified by the invention can be used for all types of air conditioning units, for example for units controlled on the water side or on the air side, and all types of refrigerant, is advantageous. For example, the system can be provided without any problems in air conditioning units which use CO₂ instead of the conventional refrigerant.

The refrigerant is advantageously branched via a controllable 3-way valve from the refrigerant circuit and supplied to the bypass line. In this case it is advantageous to provide after the branching a gas expansion valve in the bypass line to avoid overheating of the compressor. Via the adjustment of the expansion valve, which is advantageously adjustable or controllable with respect to the through-flow, the temperature of the gaseous refrigerant in the bypass line can be adjusted. If, in addition, the flow in the coolant circuit is adjustable by a coolant valve, the temperature in the heat exchanger can be optimally adjusted by effective use of the available quantity of heat.

### BRIEF DESCRIPTION OF THE DRAWING

A preferred embodiment of the heating-air conditioning unit in accordance with the invention will now be described with reference to the accompanying drawings, in which:

The sole FIGURE shows a thermodynamic supplementary heating system.

### DESCRIPTION OF A PREFERRED EMBODIMENT

The FIGURE shows a climate control system comprising an air conditioning unit and a heating unit 2. Both units share a common heat exchanger 3, which in this exemplified embodiment is constructed as a double-chamber heat exchanger. The heating unit 2 will supply the cooling water of the internal combustion engine (not represented) via the coolant line 4, it being possible to adjust the flow of the coolant by a coolant valve 5, which can be closed when necessary. The double-chamber heat exchanger 3 comprises firstly a coolant tank 6 and secondly a tank 7 for the gaseous refrigerant with the associated heat exchanger pipes (not represented). The warm cooling water supplied via the coolant line 4 flows through the coolant side of the heat exchanger before it is returned in cooled state to the engine.

The air conditioning unit 2 comprises all components of a known air conditioning unit and, when required, serves to cool the interior of the vehicle. In its circuit as the core are the compressor 8, which supplies the compressed refrigerant via a pressure line 9 to a condenser 10. Disposed behind the condenser is a collector/drier unit 11, in which the refrigerant for the expansion is treated in a following adjustable expansion valve 12. The refrigerant is finally supplied to the compressor 13, which causes the cooling of the air stream.

In accordance with the invention, behind the compressor on its pressure side a bypass line 14 branches from the pressure line 9, which bypass line can be supplied with refrigerant heated by the compressor 8. A 3-way valve 15 installed in the pressure line 9 is provided for the branching. The 3-way valve 15 can be switched by means of a drive.

Disengaged by the 3-way valve 15, the hot refrigerant is supplied via the bypass line 14 to a continuously adjustable gas expansion valve 16, via which the temperature of the refrigerant can be controlled before entering the heat exchanger 3. The refrigerant, which is cooled as required, travels via the bypass line 14 to the refrigerant side of the double-chamber heat exchanger 3 into the tank 7 for the gaseous refrigerant. After passing through the heat exchanger 3, the bypass line 14 discharges on the suction side of the compressor 8 into the refrigerant circuit. To avoid a flow of refrigerant into the compressor 13, a check valve 17, which closes in the direction of the compressor 13, is installed in the refrigerant circuit.

What we claim is:

1. A heating and air conditioning unit of a motor vehicle having a heat exchanger, a compressor and means for supply of engine coolant to the heat exchanger, the compressor being disposed in a refrigerant circuit of the air conditioning unit for the compression of a gaseous refrigerant, the unit further comprising a bypass line branching from the refrigerant circuit on the pressure side of the compressor for additional supply to the heat exchanger of heated refrigerant, whereby the bypass line, after passing through the heat exchanger discharges again into the refrigerant circuit on the suction side of the compressor.

2. The heating and air conditioning unit of claim 1, wherein the heat exchanger, has a first exchanger region through which coolant flows, and a separate exchanger region for said heated refrigerant.

3. The heating and air conditioning unit of claim 1, further comprising a controllable 3-way valve, and wherein the bypass line branches from the refrigerant circuit via said controllable 3-way valve.

4. The heating and air conditioning unit of claim 1, further comprising a gas expansion valve disposed in said bypass line.

5. The heating and air conditioning unit of claim 4, having means for regulation or adjustment of the gas expansion valve.

6. The heating and air conditioning unit of claim 1, further comprising a coolant valve for adjustment of flow in the coolant circuit.

7. The heating and air conditioning unit of claim 1 wherein the exchange temperature of the heat exchanger can be adjusted via the flow in the coolant circuit and the flow in the refrigerant circuit.

8. The heating and air conditioning unit of claim 1, further comprising a check valve, said check valve being disposed in the refrigerant circuit between the discharging bypass line and the compressor.

9. A method of operating a heating and air conditioning unit of a motor vehicle having a heat exchanger and a compressor, the heat exchanger being supplied with the coolant of the engine, the compressor being disposed in the refrigerant circuit of the air conditioning unit for the compression of a gaseous refrigerant, further comprising a bypass line branching on the pressure side of the compressor from the refrigerant circuit for additional supply to the heat exchanger of heated refrigerant via, whereby the bypass line, after passing through the heat exchanger discharges again into the refrigerant circuit on the suction side of the compressor comprising adjusting the exchange temperature of the heat exchanger using flow in the coolant circuit and flow in the refrigerant circuit.
